(19) United States
(12) Patent Application Publication
(10) Pub. No.: US 2013/0067147 A1
(43) Pub. Date: Mar. 14, 2013

(54) STORAGE DEVICE, CONTROLLER, AND READ COMMAND EXECUTING METHOD

(71) Applicant: Kazuhito OKITA, Tokyo (JP)

(72) Inventor: Kazuhito OKITA, Tokyo (JP)

(73) Assignee: Kabushiki Kaisha Toshiba, Tokyo (JP)

(21) Appl. No.: 13/606,092

(22) Filed: Sep. 7, 2012

(30) Foreign Application Priority Data
Sep. 13, 2011 (JP) 2011-199795

(51) Int. Cl. G06F 12/00

(52) U.S. Cl. 711/103

(57) ABSTRACT

A storage device of the embodiment includes memory, a control section, a table holding section for managing a table for holding an identifier, a logical address, and a data length based on a read command, an issuing section for issuing the logical address and the data length for each identifier to the control section, a buffer for holding data received from the memory along with the identifier, and an identifier queue for receiving the identifier of a number proportional to a data length when the data of the logical address of the same identifier is received in the buffer. The storage device of the embodiment includes a transfer section for transferring the data corresponding to the identifier received in the buffer to outside when the identifier is held as incomplete readout in the table in order from the identifier at a head of the identifier queue.

### CROSS-REFERENCE TO RELATED APPLICATIONS

This application is based upon and claims the benefit of priority from Japanese Patent Application No. 2011-199795, filed on Sep. 13, 2011; the entire contents of which are incorporated herein by reference.

### FIELD

Embodiments of the present invention described herein relate to a storage device, a controller, and a read command executing method.

### BACKGROUND

With increase in speed of an initiator (host) that issues a read command targeting on a SSD (Solid State Drive) including NAND flash memory, and the like, memory having a fast data transfer speed is sometimes used for a read buffer. SRAM is suited for such memory, but the SRAM has a small storage capacity compared to DRAM. Thus, enhancement in the transfer efficiency of the readout data from the storage device such as the SSD including the read buffer having a small storage capacity is desired.

However, in a conventional read command processing technique of when a scale of the read buffer is large, the readout data is randomly stored in the read buffer when a plurality of read commands received from the initiator is executed, and thus the transfer to the initiator cannot be started until the readout data with respect to each read command are all obtained in the read buffer. Therefore, firmware (F/W) needs to constantly monitor the transfer status between the NAND flash memory and the read buffer, which occupies the MPU and affects other processes and hence the transfer efficiency cannot be enhanced.

### BRIEF DESCRIPTION OF THE DRAWINGS

FIG. 1 is a block diagram illustrating a configuration of a storage device according to a first embodiment;

FIG. 2 is a function block diagram schematically illustrating an operation relationship among the function blocks according to the first embodiment;

FIG. 3 is a view illustrating a detailed configuration of a reservation exchange table holding section, a read buffer command issuing section, and an exchange executing section according to the first embodiment;

FIG. 4 is a flowchart describing a flow of a process of a read command received from an initiator according to the first embodiment;

FIG. 5 is a flowchart describing a flow of a data transfer process on an NAND side according to the first embodiment;

FIG. 6 is a flowchart describing a flow of a command execution process on an initiator side according to the first embodiment;

FIG. 7 is a timing chart illustrating a state of the read data transfer according to the first embodiment; and

FIG. 8 is a block diagram illustrating a configuration of a storage device according to a second embodiment.

### DETAILED DESCRIPTION

A storage device of the embodiment includes non-volatile memory; a memory control section; a table holding section for managing a table holding an identifier, with which a read command is identifiable, a logical address of readout data corresponding to the identifier, and readout data length corresponding to the identifier based on the read command; a read issuing section for issuing the logical address and the data length for each identifier to the memory control section; a read buffer for holding data received from the non-volatile memory based on a physical address corresponding to the logical address and the data length for each identifier instructed from the memory control section along with the identifier; and an identifier queue for receiving the identifier of a number proportional to a data length of the data when the data of the logical address is received for the same identifier in the read buffer. The storage device of the embodiment further includes a transfer section for transferring the data corresponding to the identifier received in the read buffer to outside when the identifier is held as incomplete readout in the table in order from the identifier at a head of the identifier queue.

### First Embodiment

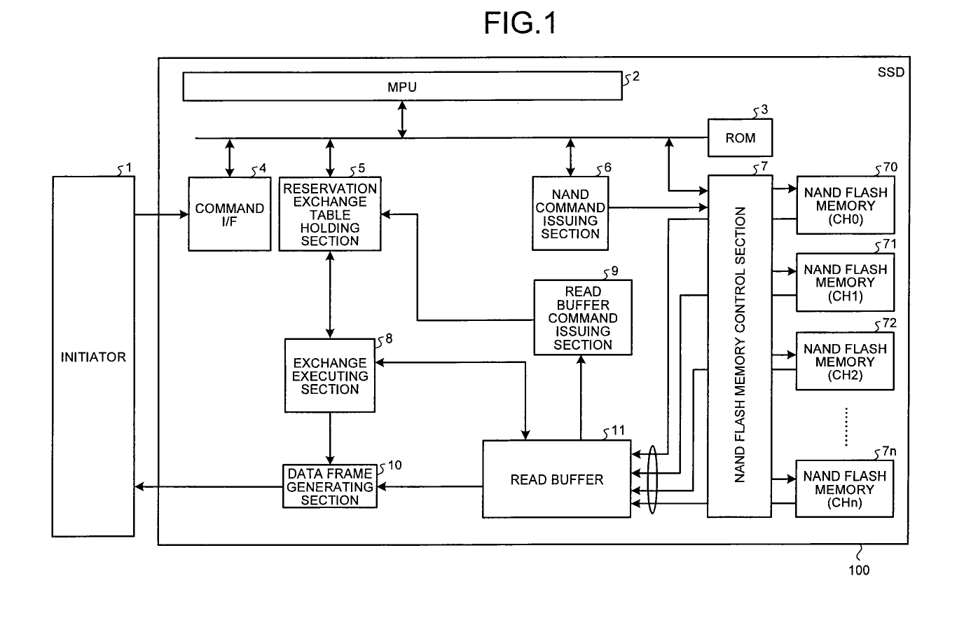

FIG. 1 is a block diagram illustrating a configuration of a storage device 100 according to a first embodiment. The storage device 100 is, for example, an SSD. An initiator 1 is connected to the storage device 100. The initiator 1 is a device adapted to issue a command to a device connected by the SCSI standard, for example. The initiator 1 corresponds to a host in the SATA (Serial Advanced Technology Attachment) standard. The initiator 1 has a role of issuing a command such as readout of data with respect to the connected storage device (target) such as the SSD.

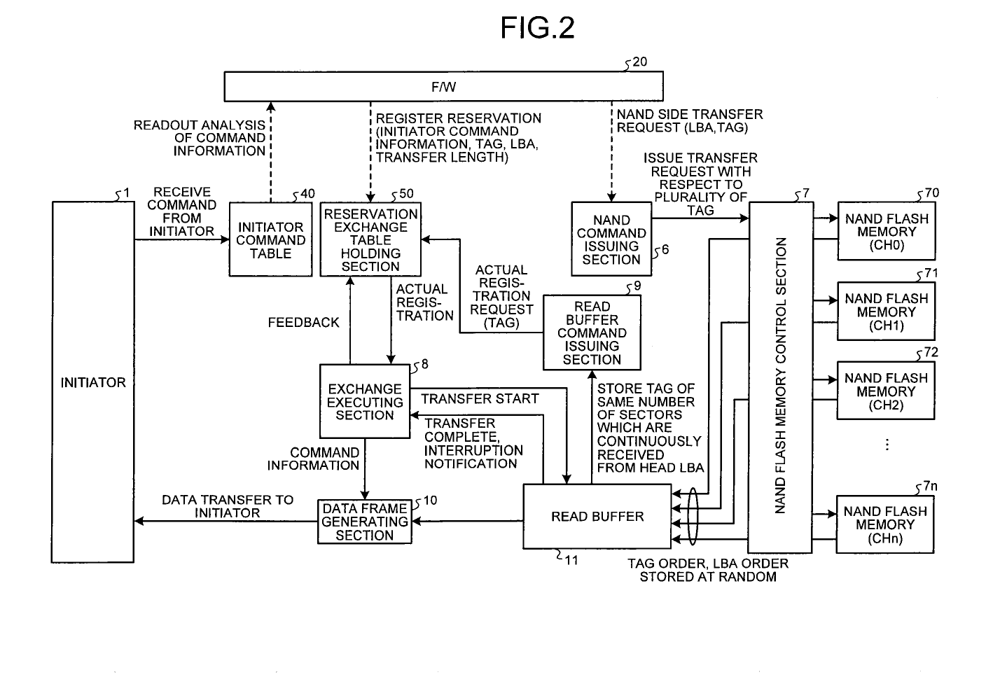

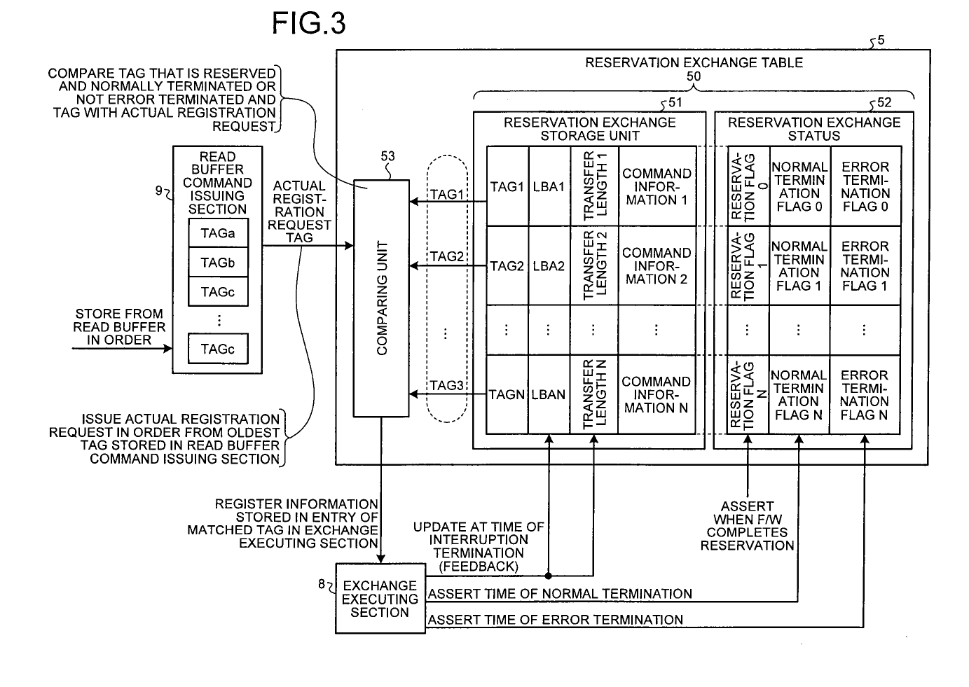

The storage device 100 includes an MPU 2, ROM 3 including EEPROM, a command I/F (interface) 4 adapted to accept the command from the initiator 1, a reservation exchange table holding section 5 to be described later, an exchange executing section 8 adapted to execute the transfer control of the readout data to the initiator 1 and rewrite of a reservation exchange table 50 (FIG. 2, FIG. 3) held by the reservation exchange table holding section 5, a data frame generating section 10 adapted to carry out the transfer of the readout data to the initiator 1, a NAND command issuing section (read issuing section) 6, a NAND flash memory control section (memory control section) 7, NAND flash memories (non-volatile memories) 70, 71, . . . , 7n in which pluralities are mounted in parallel, a read buffer command issuing section (identifier queue) 9, and a read buffer 11. The transfer of the readout data from the NAND flash memories 70, 71, . . . , 7n to the initiator 1 can be efficiently carried out by arranging the read buffer 11.

A firmware (F/W) 20 (see FIG. 2) held by the ROM 3 and executed by the MPU 2 sets the reservation exchange table holding section 5 and the NAND command issuing section 6 based on command information from the command I/F 4. To describe the operation of the storage device 100 of the present embodiment based on the operation of the firmware 20, a function block diagram schematically illustrating an operation relationship among the function blocks including the firmware 20 is illustrated in FIG. 2. A detailed configuration of the reservation exchange table holding section 5, the read buffer command issuing section 9, and the exchange executing section 8 illustrated in FIG. 2 is illustrated in FIG. 3.

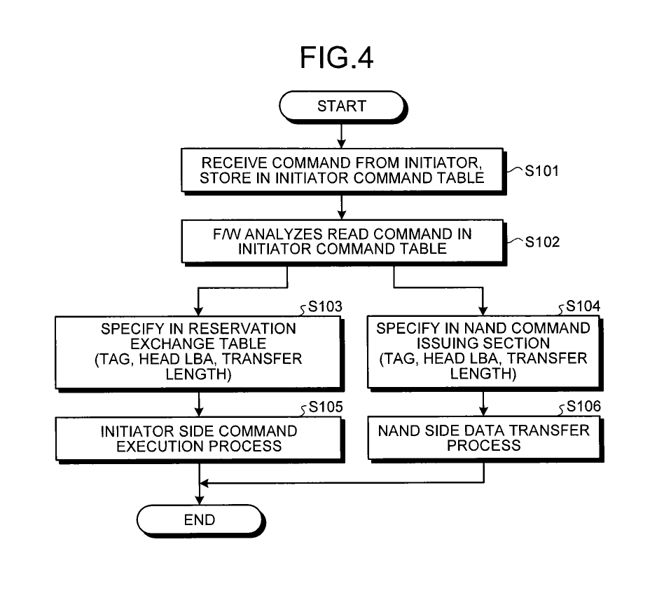

A flow of a process of a read command received from the initiator 1 in the storage device 100 will be described below using flowcharts illustrated in FIG. 1, FIG. 2, and FIG. 4 to FIG. 6.

The read command issued from the initiator 1 to the storage device 100 is received by the command I/F 4, and once stored in an initiator command table 40 managed by the command I/F 4 (FIG. 4: step S101). The firmware 20 analyzes the read command stored in the initiator command table 40 (step S102). The read command includes a logical address of a head of the readout data, and a data length (transfer length) in units of sectors from such logical address. The logical address is an address used by the initiator 1 (host), and is, for example an LBA (Logical Block Addressing), where a serial number starting from 0 is given to the sectors (size: e.g., 512 B). The logical address of the head of the readout data is hereinafter referred to as “head LBA”.

The firmware 20 gives a TAG (tag), which is an identifier that differs at least among the read commands simultaneously entered to the reservation exchange table 50, with respect to the read command received from the initiator 1 through the command I/F 4. In other words, the tag is uniquely determined with respect to the read command from the initiator 1. The firmware 20 grasps (analyzes) the TAG, the head LBA, the transfer length, and the command information with respect to each read command. The command information is, for example, a SAS (Serial Attached SCSI) address for identifying (command from) which initiator. If a plurality of initiators is connected to the storage device 100 through an expander (hub), from which initiator the command is issued can be identified by the SAS address.

The firmware 20 enters the read command to the reservation exchange table 50 of the reservation exchange table holding section 5 based on the above analysis result. Specifically, the TAG, the head LBA, the transfer length, and the command information of each read command to be executed on the reservation exchange table 50 are respectively stored for each TAG (step S103). The reservation exchange table 50 is responsible for a read command process in a function block on a side (hereinafter referred to as initiator side) close to the initiator 1 in the storage device 100. As illustrated in FIG. 3, the reservation exchange table 50 includes a reservation exchange storing unit 51 and a reservation exchange status 52. The reservation exchange storing unit 51 manages each TAG and (non-transferred) head LBA, (non) transfer length, and command information for each TAG. The reservation exchange status 52 manages a reservation flag, a normal termination flag, and an error termination flag for each TAG with respect to each TAG managed by the reservation exchange storing unit 51. At a time point the read command is entered to the reservation exchange table 50, the TAG, the head LBA, the transfer length, and the command information are written to the reservation exchange storing unit 51 by the firmware 20, and the reservation flag of the reservation exchange status 52 with respect to the TAG is asserted. At this time point, both the normal terminal flag and the error termination flag with respect to the relevant TAG are not asserted.

In parallel to the above, the firmware 20 also transmits the read command same as above to the NAND command issuing section 6. Specifically, the TAG, the head LBA, and the transfer length of each read command are stored (step S104). The NAND command issuing section 6 is responsible for the readout data transfer process on the side (hereinafter referred to as NAND side) of the NAND flash memory control section 7 and the NAND flash memories 70, 71, . . . , 7n.

Step S103 and step S104 are executed on all the read commands in the initiator command table 40. The firmware 20 is not involved in the subsequent operations. A command execution process (step S105) on the initiator side is executed after step S103, and a data transfer process (step S106) on the NAND side is executed after step S104. The command execution process (step S105) on the initiator side and the data transfer process (step S106) on the NAND side are processes respectively performed in hardware.

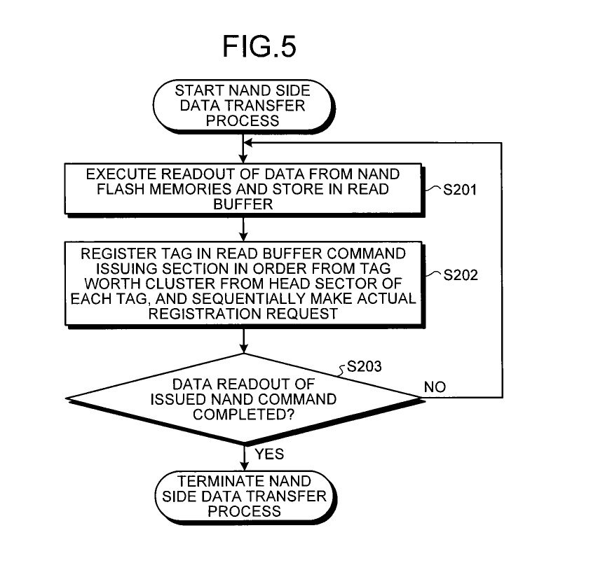

The flow of the data transfer process on the NAND side will be described based on the flowchart of FIG. 5. The NAND command issuing section 6 makes a transfer request on a stored plurality of TAGs to the NAND flash memory control section 7. In the NAND flash memory control section 7, the head LBA stored in the NAND command issuing section 6 is converted to a physical address in the NAND flash memories 70, 71, . . . , 7n, and sequentially issued from the NAND flash memory control section 7 to the NAND flash memories 70, 71, . . . , 7n as the NAND command (read command) along with the transfer length. The NAND flash memories 70, 71, . . . , 7n store the specified readout data in the read buffer 11 (step S201). In this case, the readout data stored in the read buffer 11 is asynchronously stored irrespective of the issued order of the read command, and the order of the LBA. This is because the sequential property (continuity) of the data gets lost as the write is carried out in parallel with respect to each channel of the NAND flash memories 70, 71, . . . , 7n when writing the data. It is also caused by an individual difference in the read access time of the NAND flash memories 70, 71, . . . , 7n.

The read buffer 11 grasps in units of sectors to what extent the readout data is received from the NAND flash memories 70, 71, . . . , 7n from the head LBA for each TAG. The management information such as the data length (number of sectors) for each TAG necessary therefor are provided beforehand from the firmware 20.

When receiving, from the NAND flash memories 70, 71, . . . , 7n, the data of the number of sectors continued in terms of the LBA starting from the head LBA for a certain TAG, the read buffer 11 sequentially stores the TAG of the number of sectors in the read buffer command issuing section 9. For instance, when receiving from the NAND flash memories 70, . . . , 7n, the data of the number of sectors (four sectors) of LBA=0 to 3 when the readout of the TAG=“A” is LBA=0 to 15 as a whole, and then receiving from the NAND flash memories 70, . . . , 7n, the readout data of TAG=“B”, the four TAG “A” are first sequentially stored in the read buffer command issuing section 9, and then, the TAG=“B” is stored in the read buffer command issuing section 9 by the number of continuously received sectors. Thereafter, if the readout data after LBA=4 of the TAG=“A” are continuously received from the NAND 70, . . . , 7n, the TAG=“A” is stored in the read buffer command issuing section 9 by the number of continuously received sectors. If the data of the head LBA of the TAG=“A” is received for one sector, then the data of the head LBA of the TAG=″B″ is received for one sector, and then the data of the LBA after one sector from the head LBA of the TAG=“A” (data continuing to the data of TAG=“A” received first) is received for one sector, the TAG is stored in the order of TAG=“A”, “B”, “A” in the read buffer command issuing section 9.

Generally, when reception of the data continued from the head LBA for a certain TAG is completed for one cluster (e.g., eight sectors), which is a minimum unit of the readout data from the NAND flash memories 70, 71, . . . , 7n, the read buffer 11 sequentially stores the TAG same as the number (e.g., eight) of sectors of the received one cluster in the read buffer command issuing section 9. For instance, if the readout data of TAG=“A” is stored for eight sectors continuously in terms of LBA in the read buffer 11, eight TAGs of “A” are sequentially stored in the read buffer command issuing section 9.

The read buffer 11 sequentially stores the TAG of the number corresponding to the number of sectors of the continuously received data in the read buffer command issuing section 9 every time the data of the number of sectors continued in terms of LBA from the head LBA of a certain TAG is received from the NAND flash memories 70, 71, . . . , 7n. If the reception from the NAND of the readout data continued in the order of LBA is interrupted for the relevant TAG, the relevant TAG is not stored in the read buffer command issuing section 9 until the readout data of the head LBA of the non-transferred readout data of the TAG is received from the NAND. Therefore, the readout data in the order of LBA among the same TAG are read transferred to the initiator 1 while maintaining the order of LBA according to a mechanism described later.

The read buffer command issuing section 9 is a FIFO type buffer (tag queue), as illustrated in FIG. 3, where the actual registration request is made to the reservation exchange holding section 5 for each TAG in order from the TAG stored first (step S202). In other words, the actual registration request (read buffer command) is requested in units of sectors. When the data readout from the NAND flash memories 70, 71, . . . , 7n with respect to all the NAND commands issued from the NAND flash memory control section 7 is completed (step S203: Yes), the data transfer process on the NAND side is terminated, and hence step S106 of FIG. 4 is terminated. If the data readout from the NAND flash memories 70, 71, . . . , 7n is not completed in step S203 (step S203: No), the process returns to step S201. The data transfer operation on the NAND side is as described above.

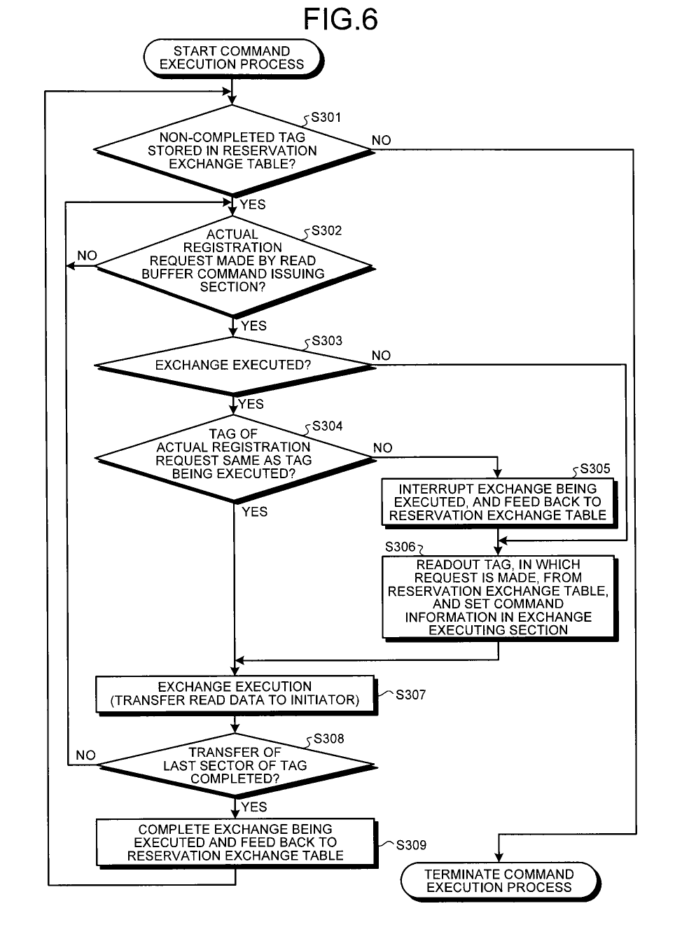

The flow of the command execution process on the initiator side will now be described based on the flowchart of FIG. 6. First, whether or not a TAG (non-completed TAG) in which the reservation flag is asserted and the normal termination flag and the error termination flag are not asserted exists in the reservation exchange status 52 of the reservation exchange table holding section 5 is determined (FIG. 6, step S301). If it does not exist (step S301: No), the command execution process is terminated. If it exists (step S301: Yes), the arrival of the actual registration request (FIG. 5, step S202) by the read buffer command issuing section 9 is waited (step S302: No). If the actual registration request is made by the read buffer command issuing section 9 to the reservation exchange table holding section 5 (step S302: Yes), whether or not the exchange executing section 8 is already operating (in exchange execution) is determined (step S303).

If the exchange executing section 8 is not operating (step S303: No), a comparing unit 53 searches for the TAG, in which the actual registration request is made, from the reservation exchange table 50. Specifically, the comparing unit 53 searches for that in which the TAG, in which the actual registration request is made, is entered in the reservation exchange storing unit 51 and the normal termination flag and the error termination flag of the reservation exchange status 52 of the TAG are both not asserted. The comparing unit 53 sets the command information of the searched TAG in the exchange executing section 8 (step S306). The exchange executing section 8 transfers the readout data of the TAG from the read buffer 11 to the data frame generating section 10, and transmits the set command information to the data frame generating section 10. The data frame generating section 10 creates the data frame based on the readout data transmitted from the read buffer 11 and the command information from the exchange executing section 8, and transfers the same to the initiator 1 (read data transfer) (exchange execution: step S307).

If the exchange executing section 8 is operating (step S303: Yes), the comparing unit 53 determines whether or not the TAG in which the actual registration request is made is the same as the TAG being exchange executed (step S304). If the TAGs are the same (step S304: Yes), the read data transfer of the same TAG is continuously carried out based on the command information being executed (step S307). If the TAG of the actual registration request is different from the TAG being exchange executed (step S304: No), the head LBA and the transfer length in the reservation exchange storing unit 51 of the TAG being exchange executed are updated. Specifically, “head LBA” is rewritten to the LBA at the head of the non-transferred sector excluding the sectors transferred up to now, and “transfer length” is rewritten to the number of non-transferred sectors. In other words, the rewrite (feedback) of the reservation exchange table 50 is carried out with the interruption of the exchange with respect to the TAG being executed (step S305). After step S305, the comparing unit 53 searches for the command information of the TAG of the actual registration request from the reservation exchange storing unit 51 and sets the same in the exchange executing section 8 (step S306). The readout data of the TAG is transferred to the initiator 1 as the data frame (step S307).

Whether or not the transfer of the final sector of the readout data of the TAG is completed is determined every time the readout data of each TAG is transferred to the initiator 1 in units of sectors in step S307 (step S308), where the arrival of the next actual registration request is waited (step S302) if not completed (step S308: No). If the transfer of the final sector of the TAG in which the readout data is transferred to the initiator 1 is completed in step S308, that is, when the transfer length of the non-transferred sector of the TAG becomes 0 (step S308: Yes), the exchange being executed is completed and fed back to the reservation exchange table 50 (step S309). Specifically, the normal termination flag of the TAG of the reservation exchange status 52 is asserted. Alternatively, the entry of the TAG may be deleted from the reservation exchange table 50. If an error occurs in one of the process of the above procedure, for instance, if the data readout from the NAND flash memories 70, 71, . . . , 7n fails or if the initiator 1 and the storage device 100 are disconnected, the error termination flag of the reservation exchange status 52 of the TAG is asserted.

In the conventional read command processing technique, when a plurality of read commands identified by the TAG=“A”, “B”, “C” received from the initiator 1 in FIG. 2 is executed, for instance, if the readout data is randomly stored in the read buffer 11 from the two channels of the NAND flash memory 70 (CH0) and the NAND flash memory 71 (CH1), the transfer to the initiator 1 cannot be started until all the readout data with respect to each read command (each TAG) are obtained in the read buffer 11. In other words, the transfer to the initiator 1 cannot be started until the last readout data of each TAG is obtained in the read buffer 11.

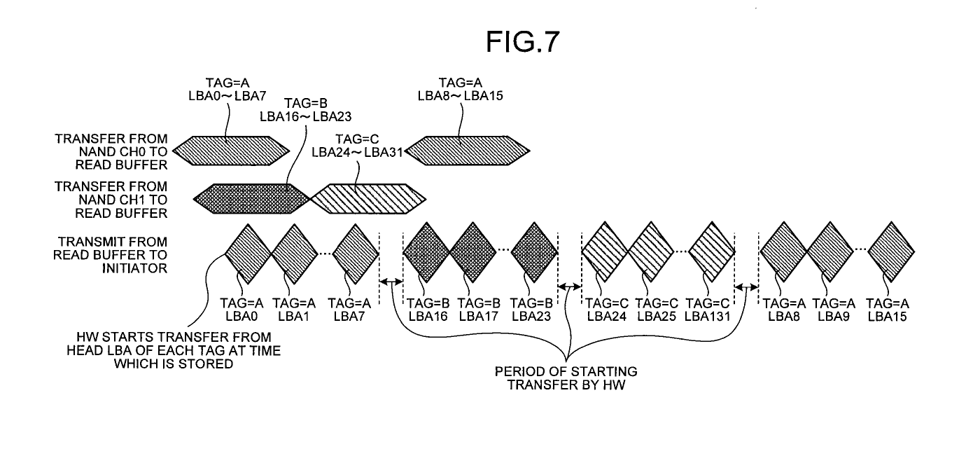

According to the read command executing method of the storage device 100 of the present embodiment, on the other hand, the read data transfer to the initiator 1 is enabled, as illustrated in the timing chart of FIG. 7. In other words, when the data transfer of three types of TAG from the two channels of the NAND flash memory 70 (CH0) and the NAND flash memory 71 (CH1) is performed, the transmission from the read buffer 11 to the initiator 1 can be carried out at the time point the readout data from the head LBA of the TAG=“A” are obtained in the read buffer 11. Thus, the read buffer 11 does not need to buffer until all the readout data with respect to each read command are obtained, and hence efficient transfer of the readout data can be enabled in the small scale read buffer 11. In other words, according to the read command executing method of the storage device 100 of the present embodiment, the firmware 20 first sets the reservation exchange table 50 and the NAND command issuing section 6 based on the read command, so that thereafter, the efficient transfer of the readout data from the read buffer 11 to the initiator 1 can be executed with only the operation of the hardware. In other words, after the setting to the reservation exchange table 50 and the NAND command issuing section 6, the efficient read data transfer can be enabled without the firmware 20 monitoring the transfer status between the NAND flash memories 70, 71, . . . , 7n and the read buffer 11.

### Second Embodiment

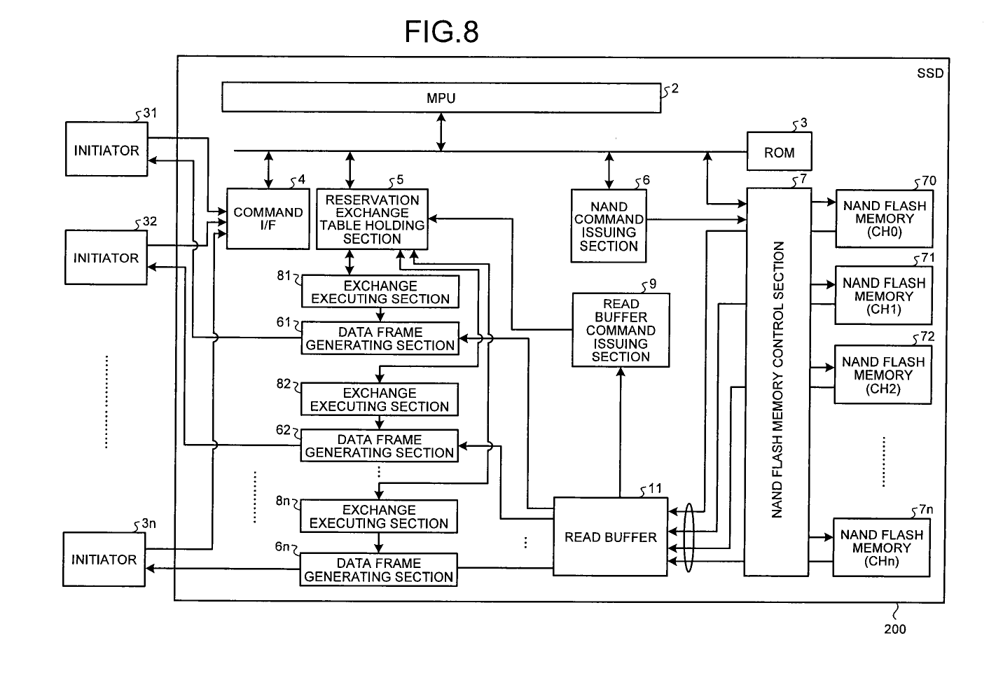

FIG. 8 is a block diagram illustrating a configuration of a storage device 200 according to a second embodiment. The storage device 200 includes a plurality of ports, so that a plurality of initiators 31, 32, . . . , 3n can be connected to the plurality of ports. The storage device 200 of the present embodiment enables an efficient execution of the read command from each of the plurality of initiators 31, 32, . . . , 3n, similar to the first embodiment. The configuration of the storage device 200 includes exchange executing sections 81, 82, . . . , 8n and data frame generating sections 61, 62, . . . , 6n respectively corresponding to each initiator 31, 32, . . . , 3n, but other configurations are similar to the storage device 100 of FIG. 1.

In the present embodiment, efficient read data transfer can be carried out, similar to the first embodiment, since from which initiator 31, 32, . . . , 3n the read command is from can be identified by the SAS address, which is the command information of the reservation exchange storing unit 51 of the reservation exchange table 50. In other words, the transfer distribution of the readout data corresponding to the read command to the respective port (initiator) can be enabled.

However, for example, if one of the ports and the initiators are disconnected, the reservation exchange table holding section 5 temporarily stops the reception of the actual registration request based on the command information (SAS address) corresponding to the actual registration request (TAG) with respect to the actual registration request (read buffer command) from the read buffer command issuing section 9 corresponding to the read command from the initiator connected to the port, so that the processing of the read command from the initiator other than the relevant port can be executed without any problems.

As described above, according to the first and second embodiments, the efficient transfer of the readout data can be enabled in the small scale read buffer without the firmware monitoring the transfer status between the NAND flash memory and the read buffer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device: comprising
non-volatile memory;
a memory control section;
a table holding section configured to manage a table holding an identifier, with which a read command is identifiable, a logical address of readout data corresponding to the identifier, and readout data length corresponding to the identifier based on the read command;
a read issuing section configured to issue the logical address and the data length for each identifier to the memory control section;
a read buffer configured to hold data received from the non-volatile memory based on a physical address corresponding to the logical address and the data length for each identifier instructed from the memory control section along with the identifier;
an identifier queue configured to receive the identifier of a number proportional to a data length of the data when the data of the logical address is received for the same identifier in the read buffer; and
a transfer section configured to transfer the data corresponding to the identifier received in the read buffer to outside when the identifier is held as incomplete readout in the table in order from the identifier at a head of the identifier queue.

2. The storage device according to claim 1, wherein when an identifier different from a transfer identifier, which is an identifier corresponding to the data transferred to outside, exists at a head of the identifier queue, the table holding section rewrites the logical address and the data length corresponding to the transfer identifier held by the table.

3. The storage device according to claim 2, wherein the table holding section rewrites the logical address corresponding to the transfer identifier to a logical address at a head of a non-transferred readout data, and rewrites the data length corresponding to the transfer identifier to a data length of the non-transferred readout data.

4. The storage device according to claim 1, wherein the table holds a flag indicating whether or not corresponding readout is completed for each identifier.

5. The storage device according to claim 4, wherein when the identifier is held as incomplete readout in the table, the flag corresponding to the identifier indicates incomplete readout.

6. The storage device according to claim 1, wherein the table holding section deletes the identifier and the data corresponding to the identifier from the table when a transfer of the readout data corresponding to the identifier to the initiator is completed.

7. The storage device according to claim 1, wherein the table further holds command information capable of identifying a read command from a plurality of initiators for each identifier.

8. The storage device according to claim 1, wherein the number proportional to the data length of the data is a number of clusters.

9. A controller comprising:
a table holding section configured to manage a table holding an identifier, with which a read command is identifiable, a logical address of readout data corresponding to the identifier, and readout data length corresponding to the identifier based on the read command;
a read buffer configured to hold data received from non-volatile memory based on a physical address corresponding to the logical address and the data length for each identifier along with the identifier;
an identifier queue configured to receive the identifier of a number proportional to a data length of the data when the data of the logical address is received for the same identifier in the read buffer; and
a transfer section configured to transfer the data corresponding to the identifier received in the read buffer to outside when the identifier is held as incomplete readout in the table in order from the identifier at a head of the identifier queue.

10. The controller according to claim 9, wherein when an identifier different from a transfer identifier, which is an identifier corresponding to the data transferred to outside, exists at a head of the identifier queue, the table holding section rewrites the logical address and the data length corresponding to the transfer identifier held by the table.

11. The controller according to claim 10, wherein the table holding section rewrites the logical address corresponding to the transfer identifier to a logical address at a head of non-transferred readout data, and rewrites the data length corresponding to the transfer identifier to a data length of the non-transferred readout data.

12. The controller according to claim 9, wherein the table holds a flag indicating whether or not the corresponding readout is completed for each identifier.

13. The controller according to claim 12, wherein when the identifier is held as incomplete readout in the table, the flag corresponding to the identifier indicates incomplete readout.

14. The controller according to claim 9, wherein the table holding section deletes the identifier and the data corresponding to the identifier from the table when a transfer of the readout data corresponding to the identifier to the initiator is completed.

15. A read command executing method of a storage device including non-volatile memory and a memory control section;
the method comprising:
holding an identifier, with which a read command is identifiable, a logical address of readout data corresponding to the identifier, and readout data length corresponding to the identifier in a table based on the read command;
reading out data to a read buffer from a physical address of the non-volatile memory corresponding to the logical address for each identifier; and
transferring data corresponding to the identifier received by the read buffer to outside when the data of the logical address is received for the same identifier in the read buffer and the identifier is held as incomplete readout in the table.

16. The read command executing method according to claim 15, further comprising rewriting the logical address and the data length corresponding to a transfer identifier held by the table when an identifier different from the transfer identifier, which is an identifier corresponding to the data transferred to outside, exists at a head of a identifier queue.

17. The read command executing method according to claim 16, wherein the rewriting includes rewriting the logical address corresponding to the transfer identifier to a logical address at a head of a non-transferred readout data, and rewriting the data length corresponding to the transfer identifier to a data length of the non-transferred readout data.

18. The read command executing method according to claim 15, wherein the table holds a flag indicating whether or not corresponding readout is completed for each identifier.

19. The read command executing method according to claim 18, wherein when the identifier is held as incomplete readout in the table, the flag corresponding to the identifier indicates incomplete readout.

20. The read command executing method according to claim 15, further comprising deleting the identifier and the data corresponding to the identifier from the table when a transfer of the readout data corresponding to the identifier to the initiator is completed.
